(19) United States
(12) Patent Application Publication
(10) Pub. No.: US 2020/0217087 A1
(43) Pub. Date: Jul. 9, 2020

(54) ELEVATOR SYSTEM

(71) Applicant: Manfred Greschbach, Herbolzheim (DE)

(72) Inventor: Manfred Greschbach, Herbolzheim (DE)

(21) Appl. No.: 16/239,992

(22) Filed: Jan. 4, 2019

(51) Int. Cl. E04F 17/00; B66B 11/00

(52) U.S. Cl. CPC E04F 17/005; B66B 11/005; B66B 11/0005

(57) ABSTRACT

An elevator system for installation on the outside of a building which extends over at least two stories and includes a shaft, a car movably mounted in the shaft for movement in a longitudinal direction of the shaft, and a drive for the car. The shaft has a shaft pit at its lower end and a through-opening for each story to be served and is configured as a prefabricated sheet-metal box made of at least one thin-walled steel plate that also extends beyond the shaft pit. The sheet-metal box forming the shaft is self-supporting, in that the steel plates extend in a straight line in the longitudinal direction of the shaft, and are profiled in a plane extending at right angles to the longitudinal direction. The steel plates are formed in one piece over the entire extent of the shaft in the longitudinal direction. A method for producing this elevator system is also provided.

### BACKGROUND

The invention relates to an elevator system for installation on the outside of a building and also a method of producing an elevator system of this type.

An elevator system of the present type therefore extends over at least two stories and comprises a shaft, a car mounted in the shaft that can be moved in a longitudinal direction of the shaft and also the drive of said car. The shaft has a shaft pit at its lower end and is provided with a through-opening for each story to be served, so that it is possible to get into and out of the car during operation, and it is configured as a prefabricated sheet-metal box made of at least one thin-walled steel plate that also extends beyond the shaft pit. An elevator system of this kind is known from BE 568 738.

Elevator shafts are traditionally made of a concrete or steel structure that is erected locally on site. This concrete or steel structure stands on a foundation which generally contains the shaft pit. This shaft pit is a kind of downwards extension of the shaft which the car does not enter but which is necessary for safety reasons and in order to accommodate different assemblies belonging to the elevator system.

Once the elevator shaft has been erected, assembly of the actual elevator comprising the car, suspension, drive and all components necessary for operation then generally takes place on site. This results in a total construction time of several weeks. This is disadvantageous particularly when the elevator is to be installed during the course of retrofitting or modernization of an existing, inhabited building, because access to the building is difficult during the construction phase.

Known solutions for eliminating the aforementioned disadvantage, in particular the solution known from BE 568 738, involve the shaft of the elevator system being produced from a plurality of thin-walled steel plates which abut one another at the corners of the usually rectangular shaft and are connected to one another there using profiles, angle irons, and the like. This allows the shaft to be prefabricated as a sheet-metal box and even allows the car and also its drive, guidance and control system to be installed in the shaft at the factory, so that the assembly time of the elevator system can be shortened significantly due to the high degree of factory prefabrication.

Irrespective of this, the prefabricated sheet-metal boxes according to the prior art which form the shaft are in need of improvement in terms of their inherent stability. This is because an elevator system that is to be installed on the outside of a building subsequently should be as inherently stable as possible, so that it does not need to be supported by the building. Elevator systems of the present kind are primarily retrofitted to older buildings which often do not have an adequately documented structural analysis. However, recalculating the structural analysis in turn leads to long delays and additional costs when retrofitting the elevator system. A free-standing elevator tower of an elevator system which is being retrofitted which is inherently stable and therefore satisfies the relevant standards and, in particular, is also able to withstand wind pressure and is torsionally rigid, may be attached to an existing building in such a manner that no fixed connections exist between the shaft and the building. The transitions between the elevator car and the building openings in the stories being served may have a floating design in a manner known in the art.

### SUMMARY

Taking this as the starting point, the objective addressed by the present invention is that of significantly reducing the time spent on assembling the elevator system on site. Moreover, the solution according to the invention should be achieved with more favorable production costs than previously.

This objective is achieved according to the invention by an elevator system having one or more features of the invention and by a method having one or more features of the invention.

Unlike in the prior art, the sheet-metal box forming the shaft has a self-supporting design according to the present invention, in that the steel plates run in a straight line in the longitudinal direction of the shaft, while they are profiled in a plane extending at right angles to the longitudinal direction of the shaft. The steel plates in this case are formed in one piece over the entire extent of the shaft in the longitudinal direction. The entire sheet-metal box in this case may be made from a single steel plate. The shaft of the elevator system according to the invention is usually produced from more than one steel plate, however, wherein the steel plates are connected to one another along the longitudinal direction of the shaft and outside profile edges, in particular by welding.

This shaft configuration may be produced in such a manner that a rectangular, planar, thin-walled steel plate, or possibly a plurality of, for example two, rectangular, planar, thin-walled steel plates is profiled lengthways in a longitudinal direction by folding—for example on a folding bench that is typically up to 18 m long—and/or by deep-drawing or, however, by roll-forming technology. These cold-forming techniques do not weaken the material. On the contrary, elongation during folding and/or deep-drawing usually strengthens the material at this point. Profiling preferably leads to edges in the sheet metal which stabilize the resulting profile, namely both in respect of bending and also in respect of twisting. In this way, the desired inherent stability of the prefabricated shaft can be achieved, namely even when the steel plates only have a wall thickness of roughly 4 mm to roughly 6 mm. The fact that the steel plates are formed in one piece according to the invention over the entire extent of the shaft in the longitudinal direction means that there is also no weakening due to a piece-to-piece addition of plates arranged over one another. A stabilizing frame and also profiles, angle irons and the like, are no longer necessary according to the invention for the desired inherent stability of the shaft.

If the through-openings for the stories being served are formed by a single intermediate space running continuously in the longitudinal direction of the shaft between the lateral edges of the single steel plate or between two free edges oriented facing one another of different steel plates connected to one another, there is no need for the prefabricated shaft to be reworked in order to introduce through-openings into the sheet-metal box for each story being served. In the prior art it was necessary in this case for corresponding through-openings to be cut out.

The edges of the steel plate or steel plates which enclose the continuously running intermediate space between them are advantageously folded in the longitudinal direction of the shaft, which further stabilizes said shaft.

The configuration of the shaft according to the invention not only allows it to be completely prefabricated in the manufacturer's works, but moreover also to be completed with all the components of the elevator system, in particular the car, its guidance and drive, all doors and the complete control system. This means that it can be brought into an operationally ready state at the manufacturer's premises and accepted by a building-regulatory organization before it is transported to the building and fitted or else installed.

The pivot bearing arranged at the lower end of the shaft, in other words at the lower end of the shaft pit, is advantageous. By this pivot bearing, the shaft is on the one hand pivoted upwards on the manufacturer's premises from the horizontal assembly position into the vertical operating position for the first commissioning and acceptance. On the other hand, the shaft may be placed in a horizontal position for its transportation to the building on a transporter and easily pivoted upwards at its destination using a crane. Once it has reached a roughly perpendicularly suspended position, the pivoting bearing is dismantled and the crane pivots the shaft to the foundation prepared on site and sets it down there.

So that the pivot bearing between the shaft and the transporter can be easily released, it is advantageously formed by at least one horizontal bore that corresponds to at least one matching counter-bore on the transport vehicle. This means that only one horizontally displaceable plug-in bolt is needed in order to create the pivot bearing or to release the pivot bearing by removing it.

A particularly advantageous development of the invention envisages that the shaft pit is terminated by a sheet-metal base and acts as lost formwork when the shaft is concreted in. All that is then needed is for a matching pit to be excavated at the shaft installation site, a reinforced foundation plate produced in this pit and then the continuous intermediate space between the shaft and pit filled with concrete after the shaft has been positioned and adjusted. The shaft pit is tightly welded outwardly and therefore simultaneously acts as a water- and oil-tight collecting trough.

The anchoring of the shaft in its concrete bed can be reinforced in that it has transversely projecting anchoring elements in the concreted-in region of its shaft pit.

It is self-evident within the framework of the invention, however, for any concreting-in of the shaft to be dispensed with and for it to be fixed using other known measures.

As a general rule, the shaft has a square, in particular rectangular, footprint. In this case, it is advisable for the steel plates to run by folding around at least one corner of the footprint and for the connection of horizontally adjacent steel plates to be made outside the corners, preferably on a rear wall of the shaft, advantageously by welding. In this way, standard steel plates with a width of roughly 3 m can be used and there is no need for each side of the shaft to have its own plate.

With regard to the wall thickness for the steel plates, a thickness of roughly 4 mm to roughly 10 mm is recommended, depending on the shaft height. This means that the shaft according to the invention is very favorable, both in terms of cost and also with regard to weight.

In the case of shafts which have a shaft head at the upper end, it is advisable for this shaft head likewise to be an integral part of the prefabricated shaft.

The method for producing the shaft according to the invention is characterized in that the shaft is prefabricated at the manufacturer's premises with all the essential components, in particular its shaft pit, its car, its guidance and drive and at least part of its control system. This prefabrication advantageously also comprises façade cladding and a finished roof cover for the shaft.

### BRIEF DESCRIPTION OF THE DRAWINGS

Further details and features of the invention result from the following description of an exemplary embodiment and from the drawings; in the drawings:

FIG. 1 shows a perspective view of the prefabricated shaft with its essential components;

FIG. 2 shows a perspective view of two folded steel plates which are welded to one another;

FIG. 3 shows a perspective view of the pit with foundation plate;

FIG. 4 shows a side view of the shaft on its transport vehicle;

FIG. 5 shows the side view according to FIG. 4, but with the shaft in the raised position;

FIG. 6 shows a perspective view of the concreted-in shaft; and

FIG. 7 shows a perspective view of the prefabricated roof structure.

### DETAILED DESCRIPTION

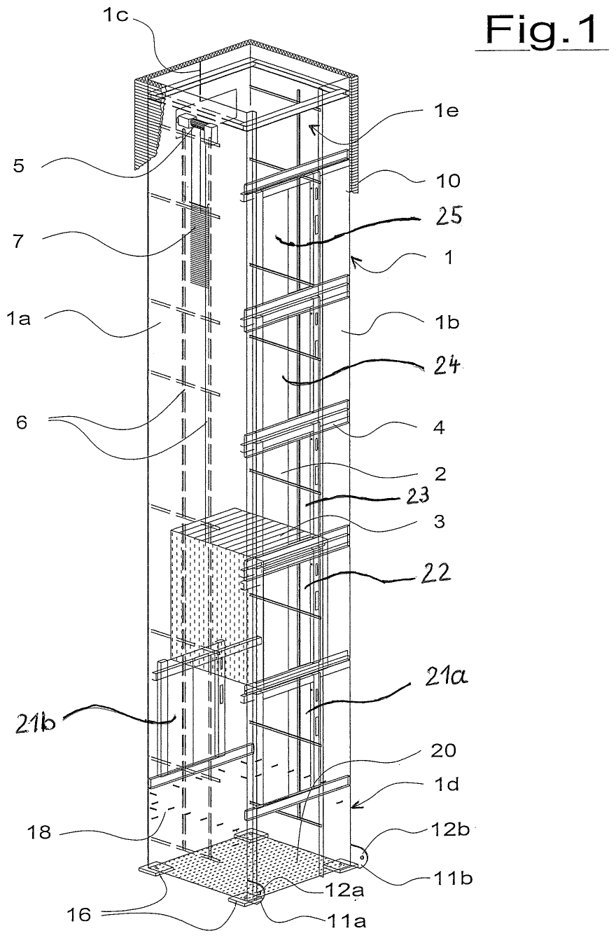

FIG. 1 shows a rectangular shaft 1 which has been produced from two folded steel plates 1a and 1b. Both steel plates 1a and 1b run through vertically and are connected to one another at their joint at the shaft rear wall along a vertically continuous weld seam 1c which is indicated at the top by a dot-dash line.

An integral component of the shaft is a shaft pit 1d located at the lower end which runs below the lowest story and, where appropriate, a shaft head 1e at the upper shaft end which runs above the first story. The shaft pit and the shaft head are therefore integrally formed extensions of the shaft.

On the front side of the shaft the plates 1a and 1b are of such dimensions that a vertically continuous intermediate space 2 is left open. This intermediate space 2 defines the horizontal position of the door openings via which the elevator car 3 can be entered and exited on each floor. The intermediate space 2 above and below the door openings in each case is bridged by reinforcing profiles 4. These reinforcing profiles connect the steel plates 1a and 1b abutting the intermediate space 2. They not only reinforce the sheet-metal box 1, but can also be used for mounting the access doors 21a, 21b, 22, 23, 24 and 25 built in on each floor.

The car 3 in the exemplary embodiment is indicated with a cable drive 5. In this case, the car is omitted to give a better view of the shaft roof and the cable suspension of the car. It goes without saying that instead of a cable drive, a hydraulic drive or a drive using threaded spindles, pinions or the like is possible.

Furthermore, vertically running guide rails 6 for guiding the car 3 and also the counterweight 7 thereof are indicated in FIG. 1.

As further shown in FIG. 1, the shaft 1 is provided at least on at least three sides with facade cladding 10. This facade cladding generally comprises thermal insulation and fire insulation and it is likewise applied as part of the prefabrication of the shaft.

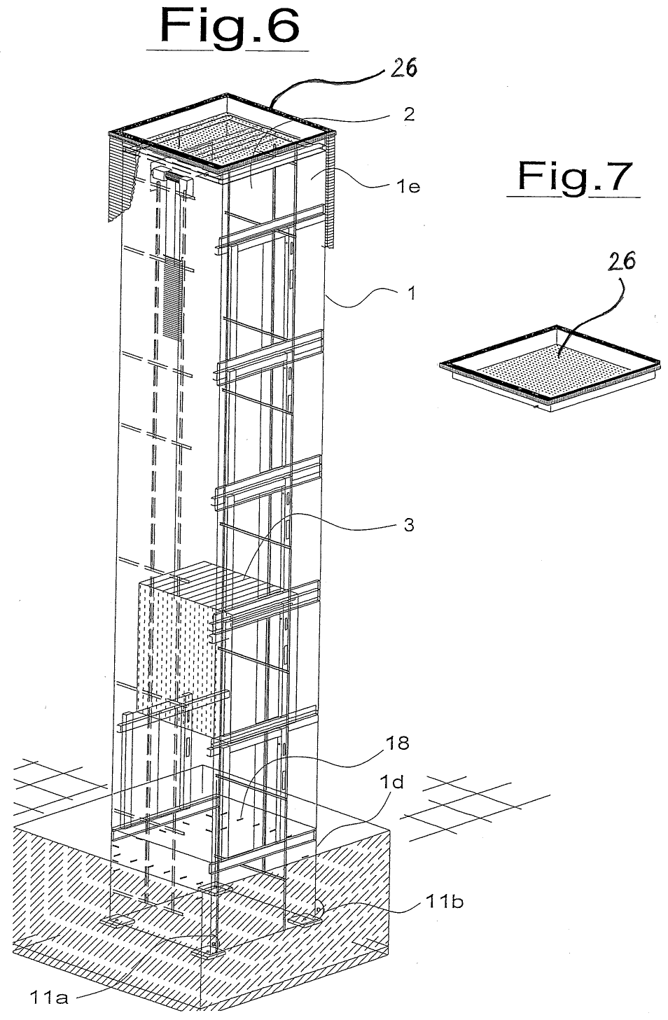

Production of the shaft also includes its completion through a prefabricated roof 26 with drainage connection pieces and an emergency overflow. This roof is not shown in FIG. 1 for reasons of clarity, but only in FIGS. 6 and 7.

As a result, the shaft 1 is therefore already fitted with all the components required to operate the elevator system at the manufacturer's end, so that it can be commissioned and tested on the manufacturer's premises.

The shaft moreover has close to its lower end two projecting lugs 11a and 11b with horizontal bearing bores 12a and 12b. These bearing bores correspond to matching bores in an assembly platform at the manufacturer's premises and also to bores on the semitrailer of a transporter, so that bolts only need be inserted horizontally into these bores, in order to produce a pivoting connection between the shaft and its assembly platform or its transporter.

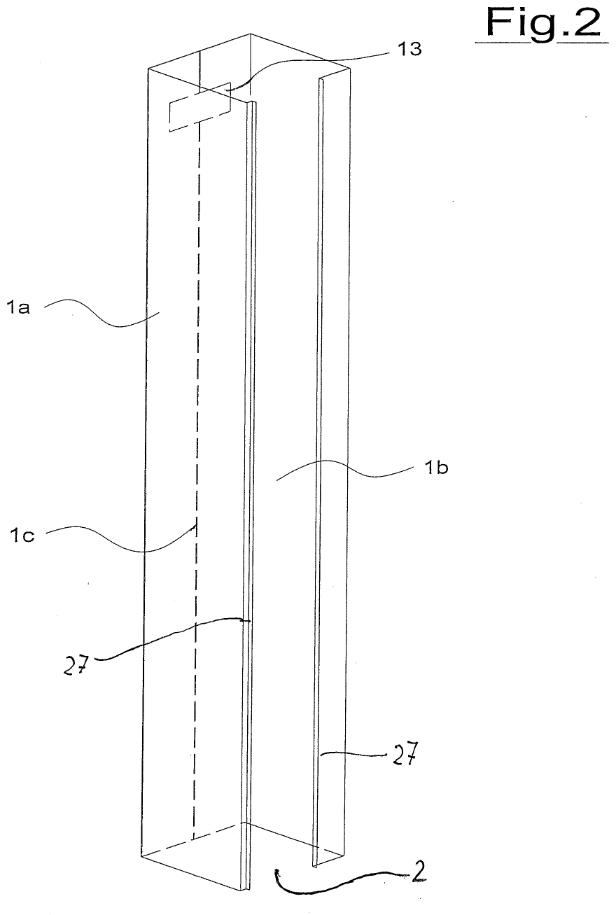

FIG. 2 shows the two steel plates 1a and 1b, after they have been folded and welded to one another along a vertical seam 1c. These are steel sheets with a standard length of roughly 15 m and a wall thickness of 6 mm. The continuous intermediate space 2 is provided at the entrance side of the shaft.

Moreover, it can be seen in FIG. 2 that a window 13 is cut out at the upper end of the shaft rear wall. This window 13 is used as a smoke outlet opening.

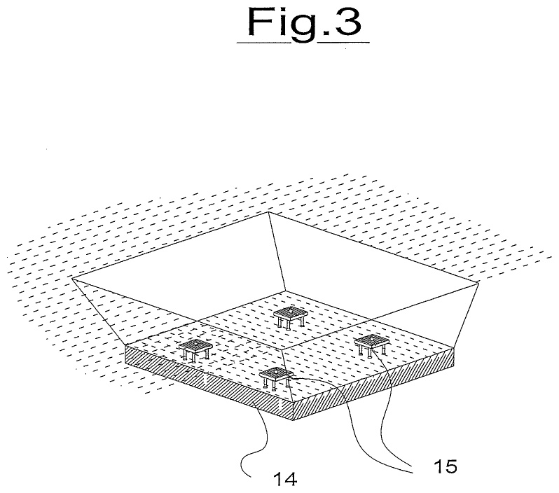

FIG. 3 shows the only work that is required on site before the shaft can be erected with its elevator ready for operation and can be attached to the building. Only one pit need be excavated, the depth of which roughly corresponds to the length of the shaft pit 1d. As a general rule, the pit depth will be roughly 1 m.

A strong foundation plate 14 must be created in this pit in a manner known per se. It bears the weight of the elevator and must therefore be reinforced. It advantageously contains bearing plates 15 in the corner regions of the shaft which create the defined footprint for erecting the shaft and therefore facilitate the perpendicular alignment thereof. The bearing plates 15 correspond to similar bearing plates 16 which are arranged at the four corners of the shaft on the underside thereof; cf. FIG. 1.

In order to facilitate the precise placement of the shaft, the bearing plates 15 and 16 may each be equipped with a conical centering pin or with a bore for receiving the same.

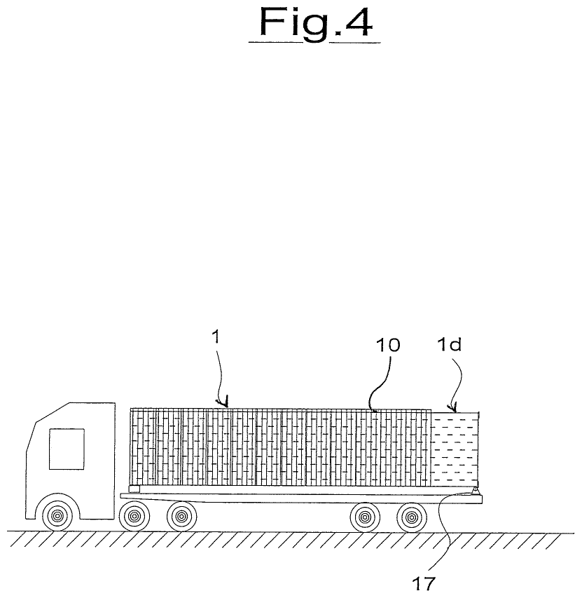

FIG. 4 shows the transportation of the shaft to the building site. In this state, the shaft is already completed with all components essential to operating the elevator. It practically only requires an electrical connection for it to be ready for operation.

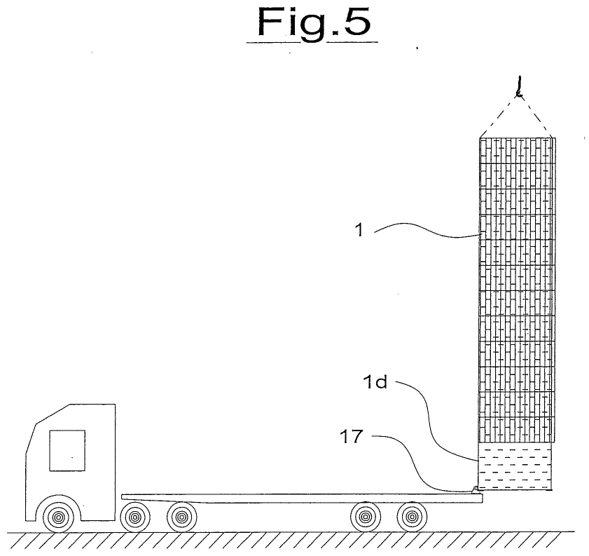

It can be seen that at its lower end, in other words in the region of its shaft pit 1d, the shaft is pivotably mounted with the help of the horizontal bores 12a and 12b arranged there via horizontal transverse bolts pivotably on matching supports 17 in the rear region—alternatively also in the front region—of the loading platform of the transporter. Consequently, a crane grabbing the shaft 1 at the front end—later at the upper end—of the shaft 1 can pivot it upwards out of its horizontal transport position into a vertical position. This is shown in FIG. 5.

As soon as the total weight of the shaft is taken by the crane, the transverse bolts inserted in the pivot bearings 11, 12 can be axially removed. The connection between the pivot bearing 11/12 of the shaft, on the one hand, and the supports 17 of the transport vehicle, on the other, is then free and the crane can transport the shaft to the foundation plate shown in FIG. 3 and set it down there. Via spacer plates or adjusting screws, the shaft can finally be moved into the precise perpendicular position.

Once the desired position of the shaft has been reached, the free space between the pit and the shaft is filled with concrete. This state is depicted in FIG. 6. It can be seen there that virtually the entire shaft pit 1b along with its tabs 11a and 11b for the pivot bearing and projecting anchoring elements in the form of head bolts 18 lies within the concrete foundation.

Moreover, FIGS. 6 and 7 show the design of the roof 26. It is preferably made of a flat sheet-metal cover with surrounding parapet. Any other roof designs are of course also possible in this case.

In summary, it can be established that at the heart of the invention is a particular construction of the elevator shaft which allows all components of a complete elevator system made up of the actual shaft as the support element, the shaft pit, the façade, the roof and all other components required for operation to be preassembled ready for operation and accepted at the manufacturer's premises, transported in one piece as a truck load to the building site, and erected there using simple lifting gear, a car crane for example, anchored and commissioned. The assembly work required hitherto in the building which extended over weeks to months can in this way be accomplished within a day.

Moreover, the shaft can be prefabricated with particularly thin walls but in an inherently stable manner which offers particular advantages when retrofitting existing buildings with an elevator system which is to be fitted to the building from the outside. The fact that no additional reinforcing elements are necessary within the shaft means that the elevator system also has a very narrow design overall, which is in turn highly advantageous for subsequent attachment to an existing staircase of a building.

1. An elevator system for installation on an outside of a building which extends over at least two stories, the elevator system comprising:
a shaft (1) including a shaft pit at a lower end thereof and a through-opening for each story to be served,
a car (3) movably mounted in the shaft that is configured for movement in a longitudinal direction of the shaft,
a drive (5) that is configured to move the car,
the shaft is configured as a prefabricated sheet-metal box made of at least one thin-walled steel plate (1a, 1b) that extends beyond the shaft pit (1d),
the sheet-metal box forming the shaft (1) is self-supporting, in that the steel plates (1a, 1b): extend in a straight line in the longitudinal direction of the shaft (1), are profiled in a plane extending at right angles to the longitudinal direction of the shaft (1), and are formed in one piece over an entire extent of the shaft (1) in the longitudinal direction.

2. The elevator system as claimed in claim 1, wherein the at least one thin-walled steel plate comprises a plurality of thin-walled steel plates (1a, 1b) to form the shaft, and the steel plates (1a, 1b) are connected to one another at edges that extend along the longitudinal direction of the shaft (1) and outside of profile edges of the shaft.

3. The elevator system as claimed in claim 1, wherein the steel plates (1a, 1b) are at least one of folded or deep-drawn for profiling.

4. The elevator system as claimed in claim 1, wherein the through-openings for the stories being served are formed by a single intermediate space (2) running continuously in the longitudinal direction of the shaft (1) between lateral edges of a single said steel plate or between two free edges (27) oriented toward one another of two or more of said steel plates (1a, 1b) that are connected to one another.

5. The elevator system as claimed in claim 4, wherein the lateral edges of the steel plate of the free edges (27) of the two or more steel plates (1a, 1b) are folded in the longitudinal direction of the shaft (1) for stabilization.

6. The elevator system as claimed in claim 1, wherein the shaft (1) has a pivot bearing (11a, 11b) with a horizontal pivot axis located at a lower end adapted for orientating the shaft from a generally horizontal transport position.

7. An elevator system that is adapted to be fitted to an outside of a building and extends over at least two stories, the elevator system comprising:
a shaft (1) with a through-opening for each of the stories and a shaft pit (1d) at a lower end thereof,
a car (3) movably mounted in the shaft,
a drive (5) that is configured to move the car,
the shaft (1) is configured as a prefabricated, self-supporting sheet-metal box made of a plurality of thin-walled steel plates (1a, 1b),
adjacent ones of the steel plates are connected to one another at edges thereof leaving open the through-openings,
the sheet-metal box also encloses the shaft pit (1d), and
a pivot bearing (11a, 11b) with a horizontal pivot axis located at a lower end of the shaft adapted for orientating the shaft from a generally horizontal transport position.

8. The elevator system as claimed in claim 7, wherein the shaft pit (1d) of the shaft (1) is terminated by a base plate (20) and acts as lost formwork when the shaft (1) is concreted in and the shaft (1) is provided with anchoring elements (18) which that are adapted to project into a concreted-in region of the shaft pit (1d).

9. The elevator system as claimed in claim 8, wherein the shaft pit (1d) has adjusting screws at a lower end thereof for perpendicular shaft orientation.

10. The elevator system as claimed in claim 7, wherein the shaft (1) has a rectangular footprint, the steel plates (1a, 1b) fold around at least one corner of the footprint, and a connection between horizontally adjacent ones of said steel plates (1a, 1b) is made outside of the corners.

11. The elevator system as claimed in claim 10, wherein the steel plates (1a, 1b) are profiled.

12. The elevator system as claimed in claim 7, wherein the steel plates (1a, 1b) have a maximum wall thickness of 10 mm.

13. The elevator system as claimed in claim 7, wherein the shaft has a shaft head (1e) at an upper end thereof and the shaft head is an integral part of the prefabricated shaft (1).

14. A method for producing an elevator system, comprising:
profiling a rectangular, planar, thin-walled steel plate (1a, 1b) in a longitudinal direction by at least one of folding, deep-drawing, or roll-forming, in order to create a sheet-metal box which runs in a straight line in the longitudinal direction and is profiled in a plane extending at right angles to the longitudinal direction to form a shaft (1) for a car (3), and orienting lateral edges (27) of the steel plate (1a, 1b) to be facing one another and forming an intermediate space (2) between the lateral edges that extends continuously in the longitudinal direction of the shaft (1),
or
profiling at least two rectangular, planar, thin-walled steel plates (1a, 1b) in the longitudinal direction by at least one of folding, deep-drawing, or roll-forming and connecting the at least two steel plates to one another along the longitudinal direction, and orienting outside profile edges thereof in order to create the sheet-metal box which runs in a straight line in the longitudinal direction and is profiled in a plane extending at right angles to the longitudinal direction to form the shaft (1) for the car (3), and orienting two free lateral edges (27) of the steel plates (1a, 1b) facing one another and forming an intermediate space (2) between the lateral edges that extends continuously in the longitudinal direction of the shaft (1), and
prefabricating the shaft (1) with a shaft pit (1d) with the car (3), a drive (5) for the car, and a guidance (6) and control system at a manufacturer's premises.

15. The method as claimed in claim 14, wherein the prefabrication also includes at least one of a number of doors (21-25) or facade cladding (10) for the shaft (1) positioned story-by-story on the shaft (1).
